(19) United States
(12) Patent Application Publication
(10) Pub. No.: US 2023/0003323 A1
(43) Pub. Date: Jan. 5, 2023

(54) PLUG-IN COUPLING FOR FLUID LINES

(71) Applicant: ContiTech MGW GmbH, Hann. Muenden (DE)

(72) Inventors: Axel Flach, Bad Wildungen (DE); Florian Kuhlhoff, Hamburg (DE)

(73) Assignee: ContiTech MGW GmbH, Hann. Muenden (DE)

(21) Appl. No.: 17/756,715

(22) PCT Filed: Oct. 26, 2020
(86) PCT No.: PCT/EP2020/080038

§ 371 Date: May 31, 2022

(30) Foreign Application Priority Data
Dec. 3, 2019 (DE) 10 2019 218 733.1

(51) Int. Cl. F16L 37/088

(52) U.S. Cl. CPC F16L 37/088

(57) ABSTRACT

A plug-in coupling for fluid lines, having a coupling sleeve (1) made of plastic, which has blocking openings (3), wherein the coupling sleeve (1) has, in the region of the blocking openings (3), at least one reinforcement (9) made of a metal material. The reinforcement (9) may have apertures (10) which correspond to the blocking openings (3) and through which a spring blocking element (5) can engage with pawls (7). As a result, it is possible to ensure that, even in the event of high contact pressures between the spring blocking element (5) and the coupling sleeve (1), separation of the blocking openings (3) can be ruled out.

The invention relates to a plug-in coupling for fluid lines, comprising at least one female line portion, which is made substantially of plastic and in which a male line portion is able to be plugged in a sealing manner, and a resilient locking device, by means of which the line portions are able to be locked together and unlocked from one another, wherein the device has at least one spring blocking element and the female line portion has blocking openings which correspond to the at least one spring blocking element.

Such plug-in couplings are known for example as VDA plug-in couplings for a large number of applications. To save weight and costs, the line portions are frequently made of plastic.

In particular when used in charge-air lines, the line portions are exposed to significant pressure fluctuations, vibrations and heat emissions from engine components.

DE 10 2012 007 670 A1 discloses a generic plug-in coupling in which the lock has a locking device, an actuating device and a preloading device. The locking device engages with blocking elements through openings in the female line portion, with the result that a male line portion is able to be locked in the female line portion by means of a corresponding groove. Via the actuation device, this lock can be undone again.

Apart from the fact that, on account of the large number of components, that solution is very complicated, it also has, like similar, known solutions, the drawback that the openings in which the blocking elements engage can be deflected, in plastics parts, by the outlined dynamic loads on the plug-in coupling. As a result, the openings can also separate and this can result in the plug-in couplings being destroyed.

The invention was based on the object of improving a plug-in coupling of the outlined type such that it withstands dynamic loads with a high degree of reliability.

This object is achieved in that the female line portion has, in the region of the blocking openings, at least one reinforcement made of a metal material.

A metal reinforcement can take a high contact pressure and so, even under dynamic loads, retaining forces of the spring blocking element engaging in the blocking openings are able to be readily taken up.

In one development of the invention, the at least one metal reinforcement is in the form of a ring which is arranged around the female line portion in the region of the blocking openings.

In this way, even under high loads, the spring blocking element butts substantially against the metal ring such that the plastics material of the female line portion is subject to less severe stresses.

In one development of the invention, the metal ring has apertures which correspond to the blocking openings such that the spring blocking element, with the coupling fully assembled, can engage both through the apertures in the metal ring and through the blocking openings.

This results in particularly good distribution of the forces of the spring blocking element.

In one development of the invention, the metal ring is in the form of a split spring ring and the female line portion has axially spaced-apart ring webs between which the split spring ring is able to be positioned such that the spring ring is fixed axially to the female line portion.

The ring webs additionally take up the forces that are transferred from the spring blocking element to the spring ring, with the result that an even better force distribution is possible.

In one development of the invention, the metal ring is in the form of a closed ring with a predetermined diameter, wherein the closed ring is able to be embedded in the plastic of the female line portion during the production of the female line portion.

The embedding of the closed ring results in optimal transfer of the forces from the spring blocking element to the female line portion.

The outlined solutions ensure more reliable force transfer from the spring blocking element to the female line portion. As a result, it is possible to ensure that, even in the event of high contact pressures between the spring blocking element and the female line portion, separation of the blocking openings can be ruled out.

Exemplary embodiments of the invention will be explained in more detail in the following text on the basis of the drawing, in which:

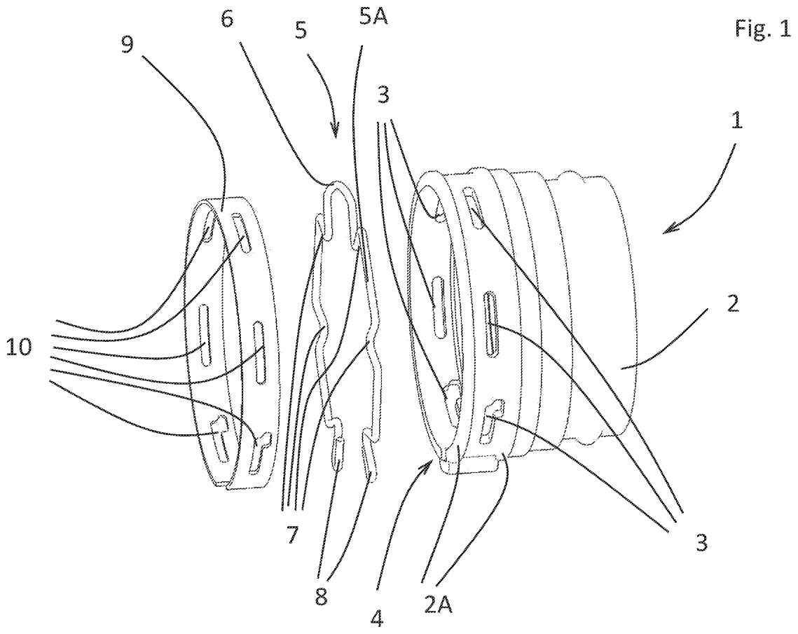

FIG. 1 shows an exploded illustration of the female line portion of a plug-in coupling according to the invention with a split spring ring,

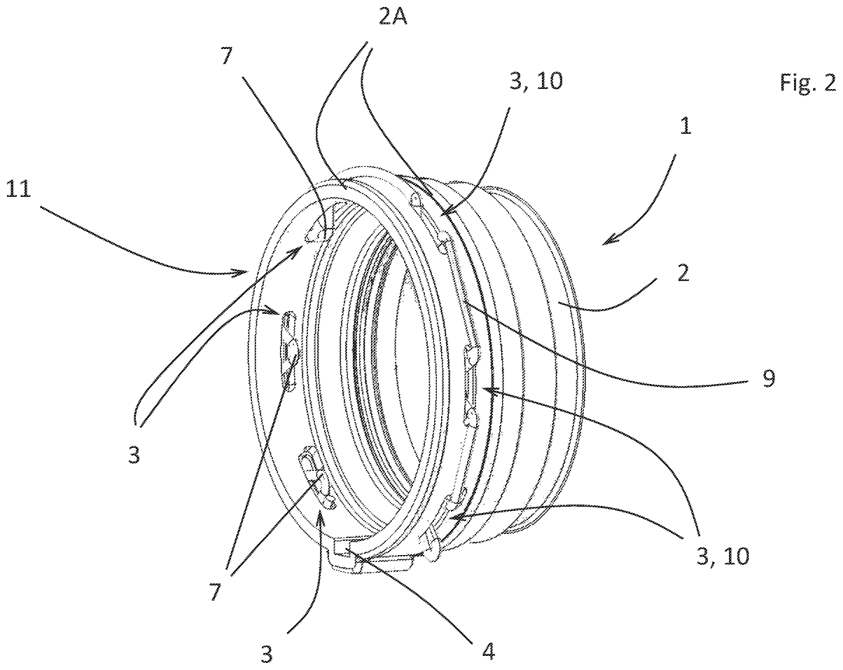

FIG. 2 shows a perspective illustration of the female line portion with a split spring ring in an assembly state, and

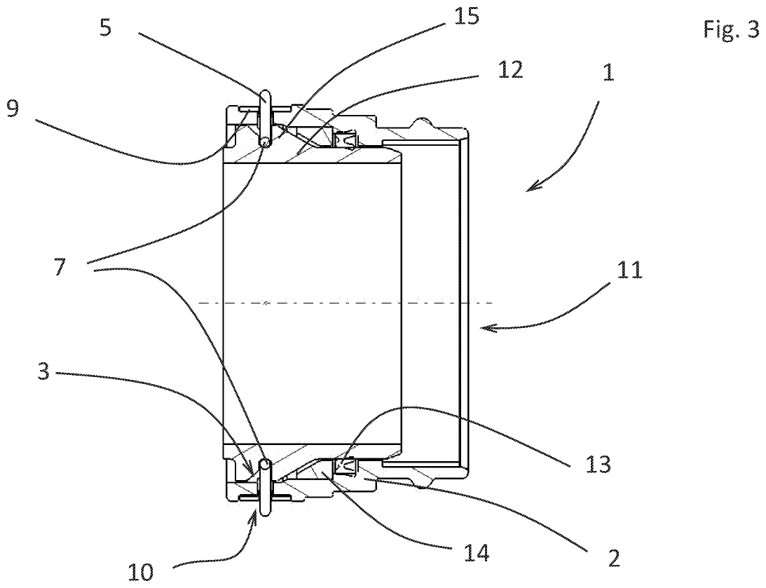

FIG. 3 shows a longitudinal section through a female line portion with a closed, embedded metal ring.

FIG. 1 shows an exploded illustration of a female part 1 of a plug-in coupling according to the invention. The female part 1 is referred to as coupling sleeve 1 in the following text and has a main body 2 with two annularly arranged, axially spaced-apart ring webs 2A. The main body 2 has, at its end assigned to a coupling plug (not shown here), annularly arranged blocking slots 3 that are spaced apart in the circumferential direction, and a cutout 4. The cutout 4 serves to receive a rotation lock (not shown here).

A blocking clip 5 has a spring bow 6 and pawls 7. The blocking clip 5 is made of spring wire 5A, wherein the spring bow 6 and pawls 7 have been formed by bending the wire 5A. To make assembly easier, the ends of the blocking clip 5 have been formed as rounded end pieces 8, likewise by bending the wire 5A.

A split reinforcement ring 9 made of metal material has apertures 10 which correspond in position and number to the blocking slots 3 in the coupling sleeve 1.

FIG. 2 illustrates a perspective view of the assembly of the coupling sleeve 1 with the reinforcement ring 9 and the blocking clip 5. The split reinforcement ring 9 has been pushed onto the main body 2 of the coupling sleeve 1 such that it comes to rest between the ring webs 2A and its apertures 10 each form an aligned opening with the blocking slots 3 in the main body 2 of the coupling sleeve 1.

The blocking clip 5 has been plugged onto the assembly made up of the main body 2 and blocking clip 5 such that its pawls 7 project through the aligned openings made up of the apertures 10 in the reinforcement ring 9 and blocking slots 3 in the main body 2 of the coupling sleeve 1.

A coupling plug (not shown here) is able to be plugged into the coupling sleeve 1, wherein the pawls 7 are able to move resiliently outward and to catch behind suitably formed elements of the coupling plug (not shown here), which is known per se.

If dynamic forces in an axial direction occur in the fully assembled coupling, these are able to be transferred to the reinforcement ring 9 via the blocking clip 5. The blocking clip 5 is supported on the ring webs 2A of the coupling sleeve 1 such that the forces are not absorbed between the pawls 7 of the blocking clip 5 and the blocking slots 3 in the coupling sleeve 1 but between the reinforcement ring 9 and the ring webs 2A. Therefore, on account of the much larger contact surfaces, the surface pressure is much lower and so separation of the blocking slots 3 is avoidable.

FIG. 3 shows a longitudinal section through a further embodiment of the coupling sleeve 1 according to the invention. In this illustration, a coupling plug 12 has been plugged into the main body 2 of the coupling sleeve 1. Arranged between the coupling plug 12 and coupling sleeve 1 are a seal 13 and a supporting ring 14. The blocking clip 5 projects with its pawls 7 through the apertures 10 and the blocking slots 3 into the interior 11 of the coupling sleeve 1 and engages behind a blocking web 15 of the coupling plug 12. In this embodiment, the reinforcement ring 9 has already been embedded in the main body 2 during the production of the main body 2 of the coupling sleeve 1, and so, in addition to the form fit, it also forms a frictional fit with the coupling sleeve 1. In this way, the force that is able to be transferred is increased and, moreover, subsequent mounting of the reinforcement ring 9 is not necessary.

### LIST OF REFERENCE SIGNS

### (Part of the Description)

1 Female part, coupling sleeve
2 Main body of the coupling sleeve 1
2A Ring webs of the main body 2
3 Blocking slots in the main body 2 of the coupling sleeve 1
4 Cutout in the main body 2
5 Blocking clip
5A Spring wire of the blocking clip 5
6 Spring bow of the blocking clip 5
7 Pawls of the blocking clip 5
8 End pieces of the blocking clip 5
9 Reinforcement ring
10 Apertures in the reinforcement ring 9
11 Interior of the coupling sleeve 1
12 Coupling plug
13 Seal
14 Supporting ring
15 Blocking web of the coupling plug 12

1.-5. (canceled)

6. A plug-in coupling for fluid lines comprising:
at least one female line portion (1) comprising plastic and in which a male line portion (12) is able to be plugged in a sealing manner; and,
at least one resilient locking device, by which the at least one female line portion (1) and the male line portion (12) are able to be locked together and unlocked from one another, wherein the device comprises at least one spring blocking element (5) and the female line portion (1) has blocking openings (3) which correspond to the at least one spring blocking element (5);
wherein the female line portion (1) has, in the region of the blocking openings (3), at least one reinforcement (9) made of a metal material.

7. The plug-in coupling as claimed in claim 1, wherein the at least one metal reinforcement (9) is in the form of a ring which is arranged around the female line portion (1) in the region of the blocking openings (3).

8. The plug-in coupling as claimed in claim 7, wherein the metal ring (9) comprises apertures (10) which correspond to the blocking openings (3) such that the spring blocking element (5), with the coupling fully assembled, can engage both through the apertures (10) in the metal ring (9) and through the blocking openings (3).

9. The plug-in coupling as claimed in claim 6, wherein the metal ring (9) is in the form of a split spring ring and the female line portion (1) has axially spaced-apart ring webs (2A) between which the split spring ring (9) is able to be positioned such that the spring ring (9) is fixed axially to the female line portion (1).

10. The plug-in coupling as claimed in claim 6, wherein the metal ring (9) is in the form of a closed ring with a predetermined diameter, and wherein the closed ring (9) is embedded in the plastic of the female line portion (1).
